(19) United States
(12) Patent Application Publication
(10) Pub. No.: US 2009/0110602 A1
(43) Pub. Date: Apr. 30, 2009

(54) Fluid reactor having a thin film with two-dimensionally distributed micro-resistor units

(76) Inventors: Chi-Yuan Lee, Jhongli City (TW); Shuo-Jen Lee, Jhongli City (TW); Chien-Heng Lin, Jhongli City (TW); Ren-De Huang, Jhongli City (TW); Wei-Jung Hsieh, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,329

(22) Filed: Jan. 24, 2008

(30) Foreign Application Priority Data
Oct. 24, 2007 (TW) 096139799

(51) Int. Cl. G01N 27/00

(52) U.S. Cl. 422/82.01

(57) ABSTRACT

A fluid reactor having a thin film with two-dimensionally distributed micro-resistor units includes one flow way, separating ribs, a thin film which is thinner than 100 micrometer, and a catalytic layer. There are multiple micro-resistor units, which is thinner than 60 micrometer each, set on the thin film. A bi-directional control unit is disposed to control these multiple micro-resistor units to shift to a desired mode selected from detecting electrical resistance, voltage, current, temperature, flow speed, and/or heat-up functions at different time. It can be applied to different kinds of fuel cells with different flow-way patterns. Its micro-resistor units have bi-directional functions. It can detect flow speed at a desired location in the flow way. It would not influence its original flow field and structure. Plus, it is easy to be installed.

### FIELD OF THE INVENTION

The present invention relates to a fluid reactor having a thin film with two-dimensionally distributed micro-resistor units. It can be applied to different kinds of fuel cells with different flow-way patterns. Its micro-resistor units have bi-directional functions. It can detect flow speed at a desired location in the flow way. It would not influence its original flow field and structure. Plus, it is easy to be installed.

### BACKGROUND OF THE INVENTION

As shown in FIGS. 1 and 2, a typical traditional micro-detector comprises:

a main body 60; a heat-insulation unit 61 that separates the main body 60 into two parts; a heat-generating unit 62 and a detecting unit 63 set on one side of the main body 60; an auxiliary unit 64 set on the other side of the main body 60.

However, the traditional micro-detector has following drawbacks:

[1] The traditional fluid detector only can detect one specific point near the fuel cell's outer surface. The traditional micro-detector is a single-point-detecting structure (not a multiple-point-detecting structure), so it only detects one specific point inside a fuel cell (or a fluid reactor). In addition, due to the length limit of its extending arm of the fluid detector, it only can detect one specific point near the fuel cell's outer surface. Under this circumstance, the traditional micro-detector cannot detect any internal zone of a fuel cell or a fluid reactor.

[2] It will severely disturb original flow field and structure. When the traditional micro-detector is used, it can be inserted into a hole to reach an internal zone of the environment (such as a fuel cell or the like) to be detected. Usually, it is protruded to a middle portion of a flow way (or channel). Thus, it would disturb the original flow field or flowing pattern of the fluid. Moreover, it is highly possible to cause the leakage of the fluid through the edge of the drilled inserting hole.

[3] It is not easy to set up. In order to set up the traditional micro-detector inside a fuel cell (or a fluid reactor), one must drill a hole on the fuel cell for installing such micro-detector. Thus, it is not easy to set up. Also, the drilling process damages the fuel cell's structure.

### BRIEF SUMMARY OF THE INVENTION

The primary object of this invention is to provide a fluid reactor having a thin film with two-dimensionally distributed micro-resistor units. It can be applied to different kinds of fuel cells with different flow-way patterns.

The second object of this invention is to provide a fluid reactor having a thin film with two-dimensionally distributed micro-resistor units. In which, the micro-resistor units have bi-directional functions.

The third object of this invention is to provide a fluid reactor having a thin film with two-dimensionally distributed micro-resistor units that can detect flow speed at a desired location in the flow way.

The fourth object of this invention is to provide a fluid reactor having a thin film with two-dimensionally distributed micro-resistor units, which would not disturb its original flow field and structure.

Another object of this invention is to provide a fluid reactor having a thin film with two-dimensionally distributed micro-resistor units. In which, it is easy to be installed.

### BRIEF DESCRIPTION OF THE DRAWINGS

FIG. 1 is a view showing the prior art.

FIG. 2 is a perspective view of the prior art.

FIG. 3 is an exploded view of the preferred embodiment of this invention.

FIG. 4 is a zoom-in view of the FIG. 3.

FIG. 5 is a zoom-in view of the FIG. 4.

FIG. 6 is a view of the preferred embodiment of this invention about flow-speed detection.

FIG. 7 is a top view of the second embodiment of this invention.

FIG. 8 is a top view of another part in FIG. 7.

FIG. 9 is a partial cross-sectional view of the second embodiment of this invention.

FIG. 10 is a top view of the third embodiment of this invention.

FIG. 11 is a top view of another part in FIG. 10.

FIG. 12 is an enlarged cross-section of a portion of FIG. 11.

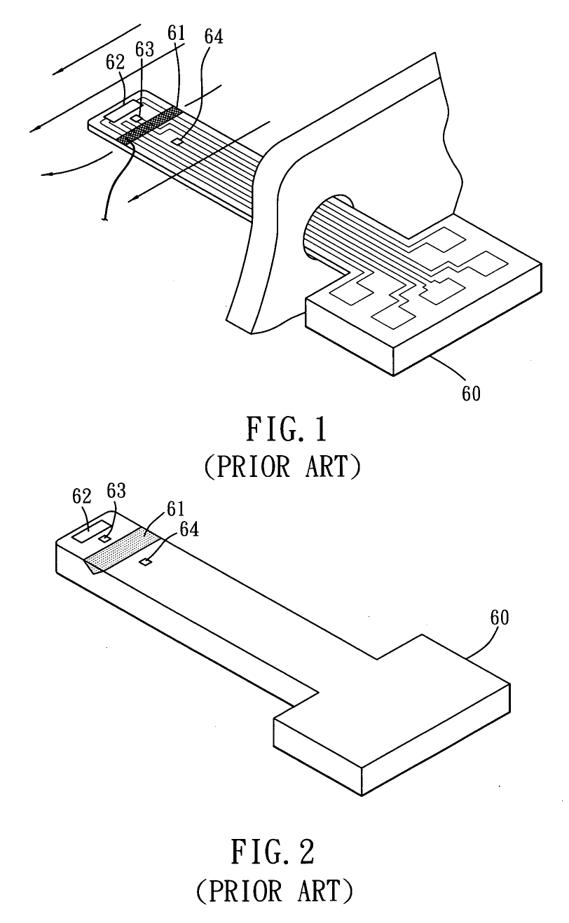

### DETAILED DESCRIPTION OF THE INVENTION

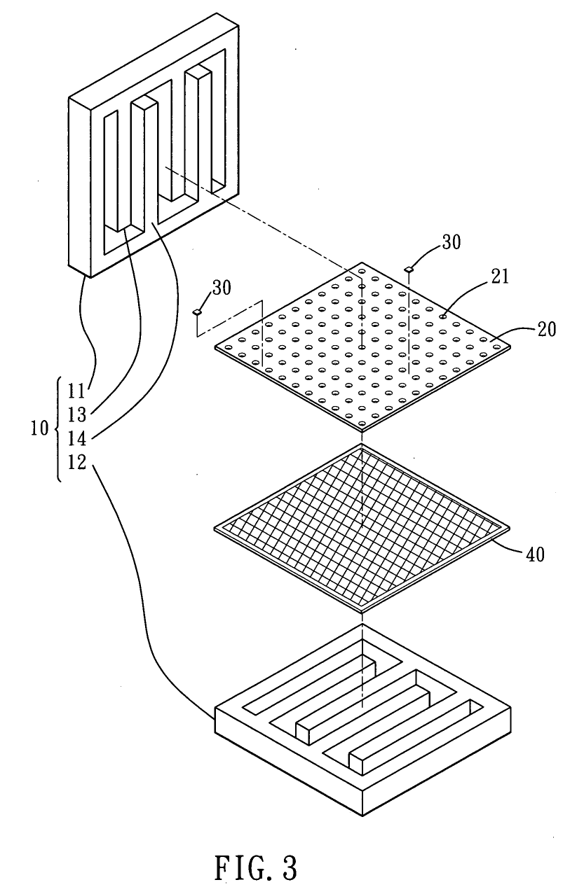

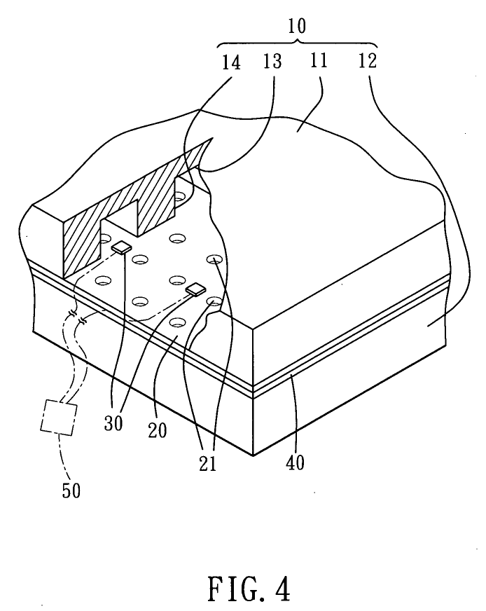

With the references to FIGS. 3, 4, and 5, the present invention is a fluid reactor having a thin film with two-dimensionally distributed micro-resistor units. It mainly comprises: a fluid reactor 10, a thin film 20, multiple micro-resistor units 30, a catalytic layer 40, and a bi-directional control unit 50.

Regarding to this fluid reactor 10, it is consisted by a first housing 11 and a second housing 12. Both of them are disposed with flow ways 13 and separating ribs 14.

About the thin film 20, it has a thickness thinner than 100 micrometer (μm). This thin film 20 has multiple holes 21 with good gas permeability.

The multiple micro-resistor units 30 are set on the thin film 20 in a matrix form of M×N (M and N are both integers), such as 10×10, 8×20, etc. Each micro-resistor unit 30 has at least two signal I/O (I/O means input/output) ports 31 and a resistor 32 between these two signal I/O ports 31. The micro-resistor unit 30 is thinner than 60 micrometer (μm).

With regard to the catalytic layer 40, it is disposed between the first and second housings 11, 12. The function of the catalytic layer 40 is to trigger certain chemical reactions for the fluids or gases.

The bi-directional control unit 50 connects with the signal I/O ports 31 of multiple micro-resistor units 30 for controlling the resistors 32 of the desired micro-resistor units 30.

Every micro-resistor unit 30 has several operational modes as follows.

[A] Temperature-detecting mode: based on the resistor value of the designated micro-resistor units 30 measured by the bi-directional control unit 50, the temperature at specific locations of the designated micro-resistor units 30 can be detected.

[B] Voltage-detecting mode: based on the voltage value of the designated micro-resistor units 30 measured by the bi-directional control unit 50, the voltage at specific locations of the designated micro-resistor units 30 can be obtained.

[C] Current-detecting mode: based on the current value of the designated micro-resistor units 30 measured by the bi-directional control unit 50, the current at specific locations of the designated micro-resistor units 30 can be detected.

[D] Reverse-heating mode: the bi-directional control unit 50 sends out the electricity to the desired micro-resistor units 30 so as to heat up the fluids or gases flowing through until they reach a predetermined level.

[E] Flow-speed detecting mode: the bi-directional control unit 50 sends out the electricity to the desired micro-resistor units 30 so as to heat up the fluids or gases flowing through; then it measures the temperature difference between its adjacent upstream and downstream micro-resistor units 30 to calculate the flow speed.

In a real practice, the multiple micro-resistor units 30 can be set on the thin film 20 in the matrix form of M×N (could be M≦10 and N≧10 or other size). Some of the multiple micro-resistor units 30 contact with the flow ways 13, and the others contact with the separating ribs 14. Besides, each the micro-resistor unit 30 can shift its operating mode at different time, if needed.

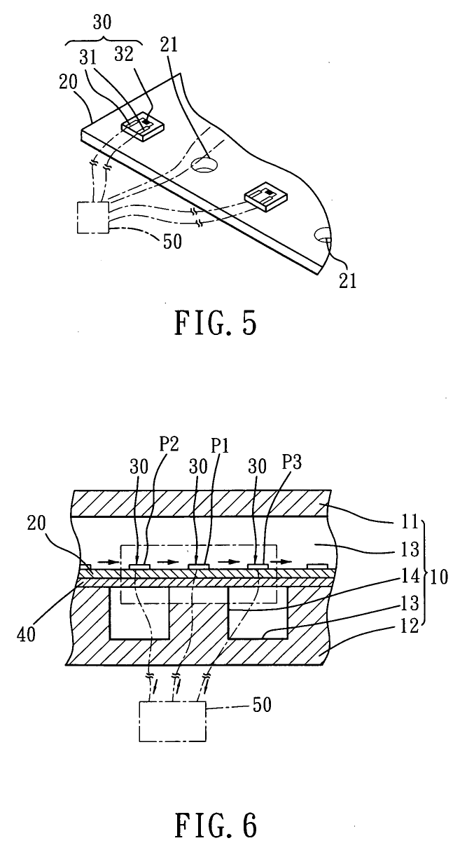

Please see the description of an embodiment (applied on fuel cell) of this invention with reference to FIG. 6. The first and second housings 11, 12 of the fluid reactor 10 are the two bipolar plates of a fuel cell. Assume that the fluid (can be gas or liquid) in the flow way flows from the left to the right. First, the bi-directional control unit 50 gives electricity to the resistor 32 (not labeled in FIG. 6, but it can be seen in FIG. 5) of one designated micro-resistor unit 30 (at location P1) to make it release predetermined thermal energy. Then, the bi-directional control unit 50 measures the temperatures of the resistors 32 at the locations at P2 and P3 respectively (that are the adjacent upstream and downstream micro-resistor units 30.

Thus, the temperature difference between the locations P2 and P3 can be measured. In addition, with reference to the data of the designated thermal energy added, the flow speed of the designated location inside the flow way 13 can be calculated (or estimated). The real-time flow speed information inside the fuel cell can enhance the control of a fuel cell to maintain at its optimum power-generating condition.

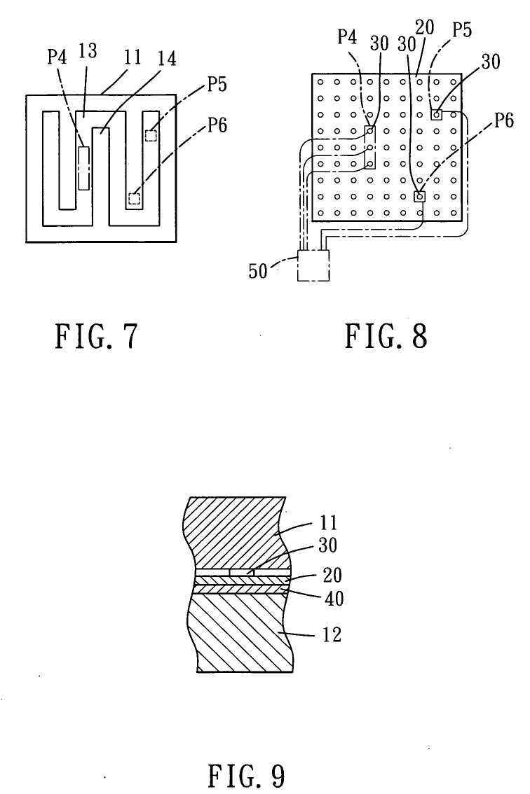

Furthermore, referring to the FIGS. 7 and 8, the thin film 20 of this invention is set between the first and second housings 11 and 12. There are several micro-resistor units 30 at location P4 (ex. taking three micro-resistor units 30 as a set), at location P5 (on the flow way 13) and at location P6 (on the separating rib 14). Accordingly, the set of three micro-resistor units 30 at location P4 can be used to determine the actual flow speed as explained in FIG. 6. Meanwhile, the micro-resistor units 30 at location P5 and P6 can be used to detect resistor value, voltage, current, temperature, and/or heat up at specific locations.

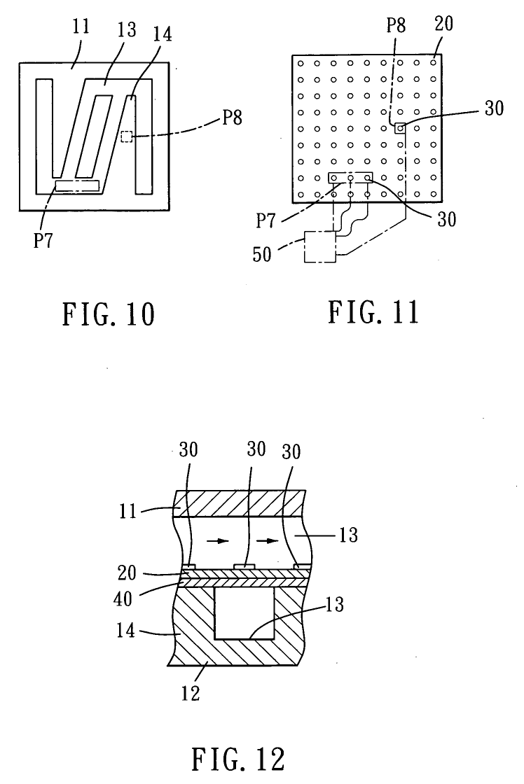

Moreover, as illustrated in the FIGS. 10 and 11, the multiple micro-resistor units 30 are set on the thin film 20 in the matrix form of M×N. Even though a fuel cell's (or fluid reactor) flow ways 13 are irregularly patterned (or shaped) due to certain needs, some micro-resistor units 30 of this invention still cover on the entire irregular flow way 13 (ex. the locations P7 and P8 in FIGS. 10 and 11) and the separating rib 14. In the FIG. 12, the three micro-resistor units 30 at location P7 (shown in FIG. 11) are enlarged for explanation. They can perform the detection of electrical resistance, voltage, current, temperature, flow speed, and/or heat-up functions.

The advantages of this invention can be summarized as follows.

[1] It can be applied on fluid reactors with various flow-way patterns. No matter how strange the flow way is, as long as the M×N number of micro-resistor units covering the entire area, the micro-resistor units of this invention always can contact with the flow way and the separating rib. Thus, it can detect or heat-up at any desired location.

[2] The micro-resistor units have bi-directional functions. They can detect electrical resistance, voltage and current internally, and output data externally for further utilization. It can also heat up the resistor from the outer part of the fluid reactor so as to control the internal temperature of the fluid reactor.

[3] It can detect the flow speed of any specific location of the flow way. The micro-resistor units are arranged on the thin film in the M×N matrix form. The bi-directional control unit can control any micro-resistor unit of designated location to detect flow speed in the flow way. Of course, it can also detect electrical resistance, voltage, current, flow speed, and temperature and it has a heat-up function.

[4] It will not influence its original flow field and structure. The thickness of the micro-resistor unit is smaller than 60 micrometer, and the thin film is also smaller than 100 micrometer in thickness. Therefore, both of them will not influence the original flow field and structure when this invention is applied on a fuel cell or the like.

[5] It's easy to be installed. Just open the fuel cell and place the thin film of this invention into the fuel cell. Then, the micro-resistor units can contact with the flow ways and separating ribs. No drilling is needed. No change is needed to the original fuel cell structure. So, it is easy and convenient for installation.

The above embodiments are only used to illustrate the present invention, not intended to limit the scope thereof. Many modifications of the above embodiments can be made without departing from the spirit of the present invention.

What is claimed is:

1. A fluid reactor having a thin film with two-dimensionally distributed micro-resistor units comprising:
a fluid reactor consisting a first housing and a second housing and forming at least one flow way and several separating ribs;
a thin film with thickness thinner than 100 micrometer, said thin film having multiple holes with good gas permeability;
multiple micro-resistor units, each of said micro-resistor unit being thinner than 60 micrometer and being set on said thin film, and each of said micro-resistor unit having at least two signal I/O ports and a resistor between said two signal I/O ports;
a catalytic layer being disposed between said first housing and said second housing so as to trigger certain chemical reactions;
a bi-directional control unit connecting with said signal I/O ports of said multiple micro-resistor units for controlling said resistors of said multiple micro-resistor units at one or more predetermined locations;
each of said micro-resistor unit having multiple operational modes including:
a temperature-detecting mode: detecting a temperature at one or more locations of designated micro-resistor units based on an electrical resistance value of said designated micro-resistor units measured by said bi-directional control unit;
a voltage-detecting mode: detecting a voltage at one or more locations of designated micro-resistor units based on a voltage value of said designated micro-resistor units measured by said bi-directional control unit;
a current-detecting mode: detecting an electrical current at one or more locations of designated micro-resistor units based on a current value of said designated micro-resistor units measured by said bi-directional control unit;
a reverse-heating mode: said bi-directional control unit sending out a heating current to at least one designated micro-resistor unit so as to heat up and reaching a designated level of thermal energy release; and
a flow-speed detecting mode: said bi-directional control unit sending out a heating current to at least one designated micro-resistor unit so as to make it reaching a designated level of thermal energy release, then measuring a temperature difference between its adjacent upstream and downstream micro-resistor units to calculate a flow speed.

2. The fluid reactor having a thin film with two-dimensionally distributed micro-resistor units as defined in claim 1, wherein the said multiple micro-resistor units are set on said thin film in a matrix form of M×N with M≦10 and N≧10, both integers, and a part of said multiple micro-resistor units contacting with said flow way while the other part of said multiple micro-resistor units contacting with said separating ribs.

3. The fluid reactor having a thin film with two-dimensionally distributed micro-resistor units in claim 1, wherein each of said multiple micro-resistor units is able shift from one mode to another mode at different time.
